(19) United States
(12) Patent Application Publication
(10) Pub. No.: US 2012/0132136 A1
(43) Pub. Date: May 31, 2012

(54) Roller for an Inking System of a Printing Machine

(75) Inventor: Tony Hollings, Lancashire (GB)

(73) Assignee: GOSS GRAPHIC SYSTEMS LIMITED, Preston Lancashire (UK)

(21) Appl. No.: 13/142,768

(22) PCT Filed: Apr. 28, 2009
(86) PCT No.: PCT/EP09/55150

§ 371 Date: Feb. 10, 2012

(30) Foreign Application Priority Data
Dec. 29, 2008 (EP) 08425817.7

(51) Int. Cl. B05C 1/00

(52) U.S. Cl. 118/200

(57) ABSTRACT

A roller to contact an oscillating ink transfer drum in an inking system for a printing machine is disclosed. It comprises a cylindrical body having a longitudinal axis and a curved outer surface. A recess is formed in the curved outer surface at an end of the cylindrical body that extends axially inward from said end of the cylindrical body by a depth that gradually reduces in a circumferential direction extending around said axis.

The present invention relates to a roller for an inking system of a printing machine. More specifically, it relates to an ink transfer roller that rolls against an oscillating ink transfer drum in an inking system for a printing machine.

A rotary printing machine includes a plate cylinder and a blanket cylinder. Printing plates are mounted to the plate cylinder for transferring an inked image to the blanket cylinder that contacts the print medium to print the resulting image. Ink is fed to the printing plates mounted on the plate cylinder by an inking unit. The inking unit of a conventional offset printing press comprises a train of ink rollers including two or three forme rollers in rolling engagement with the printing plates mounted on the plate cylinder. The forme rollers are operable to feed ink to the printing plates as the plate cylinder rotates. Printing ink is suppled to the forme rollers via the train of ink rollers from an ink fountain.

In a conventional inking system, each forme roller is in rolling engagement with a main ink distribution drum. Ink is fed to the main ink distribution drum from an ink fountain via an auxiliary drum and transfer rollers and is transferred from the main ink distribution drum to the forme rollers. A mechanism is proved to cause the main ink distribution drum and the auxiliary ink distribution drum to oscillate in a direction along their longitudinal axes, i.e. along the width of the printing press, as they rotate to cause ink to move laterally to ensure even distribution of ink across the forme rollers and, consequently, across the ink receptive areas of the printing plates. The ink distribution drum and the transfer rollers are of different diameters.

As the ink transfer rollers that transfer ink through the ink train between the auxiliary ink distribution drum, main ink distribution drum and forme rollers do not oscillate, a problem occurs in that excess ink can be pushed to the ends of the oscillating drums and rollers and builds up in the form of a bead of ink at the end of the ink transfer roller. This excess ink can fly off the drums and/or rollers and coats other machine parts, wasting ink and making the machine dirty.

The present invention seeks to overcome or substantially alleviate the problem referred to above.

According to the present invention, there is provided a roller to contact an oscillating ink transfer drum in an inking system for a printing machine, the roller comprising a cylindrical body having a longitudinal axis and a curved outer surface, wherein a recess is formed in the curved outer surface at an end of the cylindrical body, the recess extending axially inward from said end of the cylindrical body by a depth that gradually reduces in a circumferential direction extending around said axis.

In a preferred embodiment, the recess is configured such that its depth gradually reduces in a circumferential direction until it reaches or merges with the end of the cylindrical body.

The recess may be configured such that its depth reduces in a circumferential direction over an angle of 180 degrees or less.

In one embodiment, the recess is a first recess and a second recess extends axially inward from an end of the cylindrical body, the second recess extending axially inward by a depth that gradually reduces in the same circumferential direction as the first recess around said axis, wherein the depth of the second recess reduces in a circumferential direction over an angle of 180 degrees or less and is spaced in a circumferential direction from said first recess.

If there are two recesses, then the start of the second recess, where its depth is at its maximum, is spaced 180 degrees around the circumference of the cylindrical body from the start of the first recess, where its depth is at a maximum.

Each recess may have a radially extending wall, said wall defining a continuous curved surface extending in a circumferential direction around the longitudinal axis.

The continuous curved surface is preferably helically shaped.

In a particularly preferred embodiment, a recess or first and second recesses are formed in both ends of the curved outer surface of the cylindrical body. Most preferably, the recesses at each end are mirror images of each other, i.e. the ink transfer roller is symmetrical about a line extending through the middle of the roller at right-angles to its axis of rotation.

According to another aspect of the invention, there is provided an inking system for a printing machine including a roller according to the invention and an ink transfer drum having a curved surface, the roller having a first diameter and the ink transfer drum having a second diameter which is different to the first diameter, the curved surface of said roller being in contact with the curved surface of the ink transfer drum such that said ink transfer drum and roller rotate together to transfer ink from the roller to the ink transfer drum, said ink transfer drum being configured to oscillate in an axial direction during rotation to evenly distribute transferred ink across its curved surface in an axial direction.

In one embodiment, the depth of the recess gradually reduces in an anti-clockwise direction when viewed looking at the end of the roller, the roller being configured to rotate in an anti-clockwise direction to transfer ink from the roller to the ink transfer drum.

An embodiment of the invention will now be described, by way of example only, and with reference to FIG. 3 of the accompanying drawings, in which:

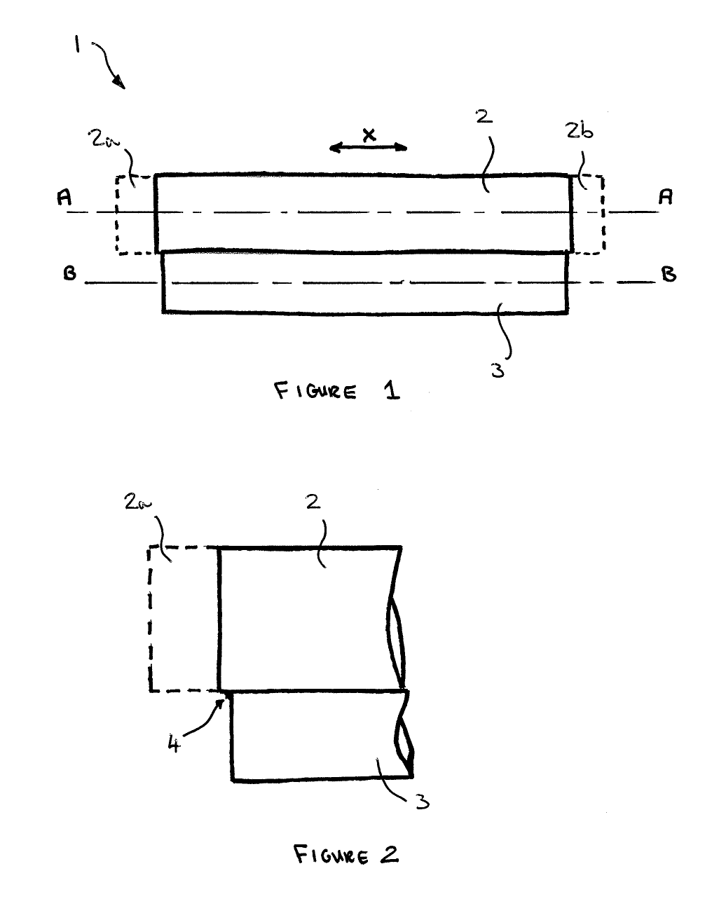

FIG. 1 is a side view of a oscillating ink distribution drum and ink transfer roller forming part of a conventional inking system;

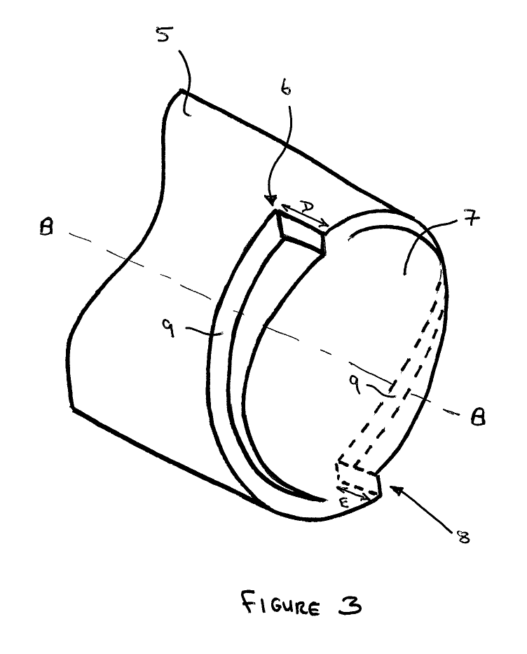

FIG. 2 is a partial enlarged view of one end of the oscillating ink distribution drum and ink transfer roller of FIG. 1; and

FIG. 3 is a perspective view of one end of the ink transfer roller according to an embodiment of the present invention.

Referring now to the drawings, there is shown in FIG. 1 a part 1 of an ink transfer system or ink train of an inking system for a printing press comprising an ink distribution drum 2 and an ink transfer roller 3. The curved cylindrical surface of the ink transfer roller 3 lies in contact with the curved surface of the ink distribution drum 2 so that ink on the ink transfer roller 3 is transferred to the ink distribution drum 3 as they rotate about the ink distribution drum rotates about its longitudinal axis “A” and the ink transfer roller 3 rotates about its longitudinal axis “B”. It will be appreciated that the ink transfer roller 3 and ink distribution drum 2 are of different diameters, as is conventional, to ensure that any patterns formed in the ink on the surface of the roller 3 or ink distribution drum 2 is not reinforced as they rotate but is eradicated due to the procession of the rollers 2, 3.

The ink distribution drum 2 is mounted so that it can oscillate in an axial direction (in the direction of arrow “X” in FIG. 1) as it rotates. The extremes of movement of the ink distribution drum are shown by the dashed lines marked 2a and 2b. This oscillation of the ink distribution drum 2 is well-known in the art and serves to move ink in a widthwise direction across the surface of the ink distribution drum 2 to ensure that an even coating of ink is transferred to the plate cylinder of the press. The frequency of oscillation is generally in the region of between 3.5 and 4 Hz and the extent of the oscillation may be in the order of approximately 25 mm.

An enlarged view of the left hand end of the ink distribution drum 2 and ink transfer roller 3 is shown in FIG. 2, from which it can be appreciated that, during oscillation and rotation of the drum 2 and roller 3, excess ink is pushed to the ends and builds up in the form of a bead 4, that forms between the ink distribution drum 2 and ink transfer roller 3. This excess ink may be sprayed off the roller 3.

One end of a modified ink transfer roller 5 according to an embodiment of the present invention, is shown in FIG. 3. Although only one end of the roller 5 is shown, it will be appreciated that the other end of the roller 5 may have the same configuration. Ideally the other end has a mirror-image recess so that the roller can be mounted for rotation in either direction. Preferably, the roller 3 is mounted for rotation in the direction of arrow “X” in FIG. 3, although it is envisaged that it could be mounted for rotation in either direction.

As can be seen from FIG. 3, the end of the roller 5 is provided with a recess, shoulder or cut-out portion 6 which extends inwardly from the end wall 7 of the roller 5 and extends around the circumference of the roller 5 by an angle of approximately 180 degrees or less. A second, identical recess, shoulder or cut-out portion 8 extends circumferentially around the remaining circumference of the roller 5 and is shown in dashed lines in the Figure. The or each recess essentially has a “saw-tooth” shape.

The recess 6 has a maximum depth at the point indicated by arrow “D”, i.e. at the 12 o'clock position as the roller is shown in the Figure. The “depth” referred to here is the extent of the recess 6 in an axially inwardly extending direction from the end wall 7. The maximum depth “D” may be in the order of about 16 mm or in the order of about half the oscillation distance. The depth of the recess 6 gradually reduces in a circumferential direction extending around said axis, i.e. in a anti-clockwise direction, as shown in the Figure, until it merges into or meets the end wall 7. The second recess 8 has its maximum depth (indicated by arrow “E”) at a location which is 180 degrees around the circumference of the roller 5.

Each recess 6,8 has a bottom radially extending wall 9 which defines a continuous curved surface extending in a circumferential direction around the longitudinal axis B of the ink transfer roller 5. In a preferred embodiment of the invention, this surface is helically shaped. The wall 9 has an edge 9a.

During rotation, it will be appreciated that a bead of ink may still form on the surface of the ink distribution drum 2, but rather than extending circumferentially around the drum at right-angles to its axis of rotation, it is now follows an angled or part helical path around the circumference, defined by the upper edge 9a of the wall 9. Because of this, a at least a portion of the bead is continuously “run-over” or picked-up by the ink transfer drum 2 in subsequent revolutions due to the procession of the ink distribution drum 2 and transfer roller 3 as they rotate, so that the ink forming the bead is being continuously dragged back into the main body of ink, thereby maintaining a layer of ink of substantially constant thickness across the surface of the ink distribution drum 2 and ink transfer roller 3.

It will be appreciated that the foregoing description is given by way of example only and that modifications may be made to the transfer roller of the present invention without departing from the scope of the appended claims.

1. A roller to contact an oscillating ink transfer drum in an inking system for a printing machine, the roller comprising a cylindrical body having a longitudinal axis and a curved outer surface, wherein a recess is formed in the curved outer surface at an end of the cylindrical body, the recess extending axially inward from said end of the cylindrical body by a depth that gradually reduces in a circumferential direction extending around said axis.

2. A roller according to claim 1, wherein the recess is configured such that its depth gradually reduces in a circumferential direction until it reaches the end of the cylindrical body.

3. A roller according to claim 1, wherein the recess is configured such that its depth reduces in a circumferential direction over an angle of 180 degrees or less.

4. A roller according to claim 3, wherein said recess is a first recess and a second recess extends axially inward from an end of the cylindrical body, the second recess extending axially inward by a depth that gradually reduces in the same circumferential direction as the first recess around said axis, wherein the depth of the second recess reduces in a circumferential direction over an angle of 180 degrees or less and is spaced in a circumferential direction from said first recess.

5. A roller according to claim 4, wherein the start of the second recess, where its depth is at its maximum, is spaced 180 degrees around the circumference of the cylindrical body from the start of the first recess, where its depth is at a maximum.

6. A roller according to claim 1, wherein the or each recess has a radially extending wall, said wall defining a continuous curved surface extending in a circumferential direction around the longitudinal axis.

7. A roller according to claim 6, wherein the continuous curved surface is helically shaped.

8. A roller according to claim 1, wherein a recess or first and second recesses are formed in both ends of the curved outer surface of the cylindrical body.

9. An inking system for a printing machine including a roller as recited in claim 1 and an ink transfer drum having a curved surface, the roller having a first diameter and the ink transfer drum having a second diameter which is different to the first diameter, the curved surface of said roller being in contact with the curved surface of the ink transfer drum such that said ink transfer drum and roller rotate together to transfer ink from the roller to the ink transfer drum, said ink transfer drum being configured to oscillate in an axial direction during rotation to evenly distribute transferred ink across its curved surface in an axial direction.

10. An inking system according to claim 9, wherein the depth of the recess gradually reduces in an anti-clockwise direction when viewed looking at the end of the roller, the roller being configured to rotate in an anti-clockwise direction to transfer ink from the roller to the ink transfer drum.

11. An inking system including the roller recited in claim 1.
